(19) United States
(12) Patent Application Publication
(10) Pub. No.: US 2017/0307019 A1
(43) Pub. Date: Oct. 26, 2017

(54) Seal Assembly For A Turbomachine

(71) Applicant: Dresser-Rand SAS, Le Havre (FR)

(72) Inventors: Laurent Vicogne, Le Havre (FR); Alain Vandecavez, Remuée (FR)

(21) Appl. No.: 15/516,960

(22) PCT Filed: Oct. 7, 2014
(86) PCT No.: PCT/IB2014/002049

§ 371 Date: Apr. 5, 2017

(51) Int. Cl. F16C 33/74; F16J 15/3268; F16J 15/328; F01D 11/00; F01D 25/16

(52) U.S. Cl. CPC F16C 33/74; F16J 15/3268; F16J 15/328; F01D 25/16; F01D 11/003; F05D 2220/31

(57) ABSTRACT

A seal assembly for a bearing housing is provided. The seal assembly may include a rotor seal member configured to be in sealing engagement with a rotary shaft. The seal assembly may also include a stator seal member formed from a plurality of stator seal member segments and configured to be in sealing engagement with the bearing housing. The stator seal member may also include an annular stator outer surface configured to be disposed on an inner surface of the bearing housing in sealing engagement therewith, and an annular stator inner surface radially opposing the annular stator outer surface and forming a first stator inner annular groove configured to receive the rotor seal member therein and form a sealing engagement therewith.

### BACKGROUND

The shaft of a typical steam turbine is supported for rotation by one or more bearings arranged within a bearing case. Typical bearings used for this purpose are oil-lubricated journal bearings, which are protected from contamination via a bearing case seal, such as a labyrinth seal or brush seal. The presence of humidity and increased temperatures at the bearing case seal location allows moisture and other impurities (e.g., particulates, such as sand) to migrate through conventional bearing case seals and eventually accumulate inside the bearing case, thereby contaminating the bearing lubricating oil and oil reservoir and damaging the bearing case seal. Thus, steam turbines, even standby service units, are vulnerable to damage to or contamination of the bearing lubricating oil, which leads to a general degradation of the lubricating properties of the oil and can result in premature failure of the journal bearings.

In order to avoid premature failure of the bearings, turbine operators must frequently drain the bearing lubrication systems and replace the lubricating oil, and additionally, if damaged, replace the bearing case seal. How frequent such servicing is required depends on the operating steam conditions, the wear of the steam and oil seal components, and the severity of the moisture or other contaminant accumulation within the bearing case. Servicing the bearing lubrication system and replacing the damaged bearing case seal can be rather time-consuming and often requires the turbine to be put off line, thereby losing valuable operating time and costs.

The time required for the servicing of the bearing lubrication system is typically based in part on the ease of replacing the bearing case seal, which generally includes disassembling the damaged bearing case seal and installing a replacement bearing case seal. In bearing lubrication systems utilizing force feed systems, a bearing case seal assembly may be employed including a bearing case seal and a baffle, which may result in additional time required to replace the bearing case seal assembly. Further, the bearing case seal assemblies of such bearing lubrication systems may employ a liquid sealant, known to those in the art as RTV 732 silicone sealant, which may be hazardous to the health of operators in certain circumstances.

What is needed, therefore, is a bearing case seal assembly that reduces or entirely restricts the influx of moisture and other contaminants into the bearing case and requires minimal installation or maintenance time.

### SUMMARY

Embodiments of the disclosure may provide a seal assembly for a bearing housing. The seal assembly may include a rotor seal member defining a borehole configured for a rotary shaft to extend therethrough. The rotor seal member may be configured to be in sealing engagement with the rotary shaft. The seal assembly may also include a stator seal member formed from a plurality of stator seal member segments and configured to be in sealing engagement with the bearing housing. The stator seal member may include a first stator axial end face adjacent a first rotor axial end face, and a second stator axial end face axially opposite the first stator axial end face and configured to be disposed at or adjacent to an axial end of the bearing housing. The stator seal member may also include an annular stator outer surface configured to be disposed on an inner surface of the bearing housing in sealing engagement therewith, and an annular stator inner surface radially opposing the annular stator outer surface and forming a first stator inner annular groove configured to receive the rotor seal member therein and form a sealing engagement therewith.

Embodiments of the disclosure may further provide a seal assembly for a bearing housing of a turbomachine. The seal assembly may include an annular rotor seal member defining a borehole configured to receive a rotary shaft of the turbomachine, a first stator seal member segment comprising an alignment member, and a second stator seal member segment defining an opening configured to receive and seat the alignment member. The first stator seal member segment and the second stator seal member segment may be axially aligned and form an annular stator seal member with the alignment member seated within the opening. The annular stator seal member may include an annular stator seal member outer surface and an annular stator seal member inner surface disposed radially inward from the annular stator seal member outer surface. The annular stator seal member may form a first stator inner surface annular groove disposed adjacent an axial end face of the annular stator seal member and configured to receive the annular rotor seal member therein and to form a sealing engagement therewith. The annular stator seal member may also form a second stator inner surface annular groove configured to direct lubricant to a sump formed in the bearing housing. The second stator inner surface annular groove may be disposed adjacent an opposing axial end face of the axial end face of the annular stator seal member. The annular stator seal member may further form a stator outer surface annular groove and a stator annular projection extending radially outward from the annular stator seal member outer surface and disposed adjacent the stator outer surface annular groove. The stator annular projection may be configured to be received in an inner surface groove of the bearing housing, such that axial movement of the annular stator seal member in relation to the bearing housing is prevented.

Embodiments of the disclosure may further provide a method for assembling a seal assembly in a bearing housing. The method may include disposing a first stator seal member segment in the bearing housing in a sealing arrangement with an inner surface of the bearing housing. The method may also include mounting a rotor seal member on a rotary shaft, such that the rotor seal member and the rotary shaft are in sealing engagement. The method may further include disposing the rotor seal member within a first stator inner annular groove formed in an inner annular surface of the first stator seal member segment and mating a second stator seal member segment to the first stator seal member segment via an alignment member. The first stator seal member segment and the second stator seal member segment may be axially aligned and the rotor seal member may be disposed within a first stator inner annular groove formed in an inner annular surface of the second stator seal member segment.

### BRIEF DESCRIPTION OF THE DRAWINGS

The present disclosure is best understood from the following detailed description when read with the accompanying Figures. It is emphasized that, in accordance with the standard practice in the industry, various features are not drawn to scale. In fact, the dimensions of the various features may be arbitrarily increased or reduced for clarity of discussion.

FIG. 1 illustrates a perspective view of a turbine in which an embodiment of the seal assembly of the present disclosure may be installed.

FIG. 2 illustrates a perspective view of a bearing case of the turbine shown in FIG. 1, where a first housing section of the bearing case has been removed.

FIG. 3 illustrates an exploded view of a seal assembly, according to one or more embodiments of the disclosure.

FIG. 4 illustrates a perspective, cutaway view of a seal assembly, according to one or more embodiments of the disclosure.

FIG. 5A illustrates an exploded view of a first portion of a seal assembly disposed in the bearing case of the turbine shown in FIG. 1.

FIG. 5B illustrates an exploded view of a second portion of a seal assembly disposed in the bearing case of the turbine shown in FIG. 1.

FIG. 6 illustrates a schematic flowchart of a method for assembling a seal assembly, according to one or more embodiments disclosed.

### DETAILED DESCRIPTION

It is to be understood that the following disclosure describes several exemplary embodiments for implementing different features, structures, or functions of the invention. Exemplary embodiments of components, arrangements, and configurations are described below to simplify the present disclosure; however, these exemplary embodiments are provided merely as examples and are not intended to limit the scope of the invention. Additionally, the present disclosure may repeat reference numerals and/or letters in the various exemplary embodiments and across the Figures provided herein. This repetition is for the purpose of simplicity and clarity and does not in itself dictate a relationship between the various exemplary embodiments and/or configurations discussed in the various Figures. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact. Finally, the exemplary embodiments presented below may be combined in any combination of ways, i.e., any element from one exemplary embodiment may be used in any other exemplary embodiment, without departing from the scope of the disclosure.

Additionally, certain terms are used throughout the following description and claims to refer to particular components. As one skilled in the art will appreciate, various entities may refer to the same component by different names, and as such, the naming convention for the elements described herein is not intended to limit the scope of the invention, unless otherwise specifically defined herein. Further, the naming convention used herein is not intended to distinguish between components that differ in name but not function. Additionally, in the following discussion and in the claims, the terms “including” and “comprising” are used in an open-ended fashion, and thus should be interpreted to mean “including, but not limited to.” All numerical values in this disclosure may be exact or approximate values unless otherwise specifically stated. Accordingly, various embodiments of the disclosure may deviate from the numbers, values, and ranges disclosed herein without departing from the intended scope. Furthermore, as it is used in the claims or specification, the term “or” is intended to encompass both exclusive and inclusive cases, i.e., “A or B” is intended to be synonymous with “at least one of A and B,” unless otherwise expressly specified herein.

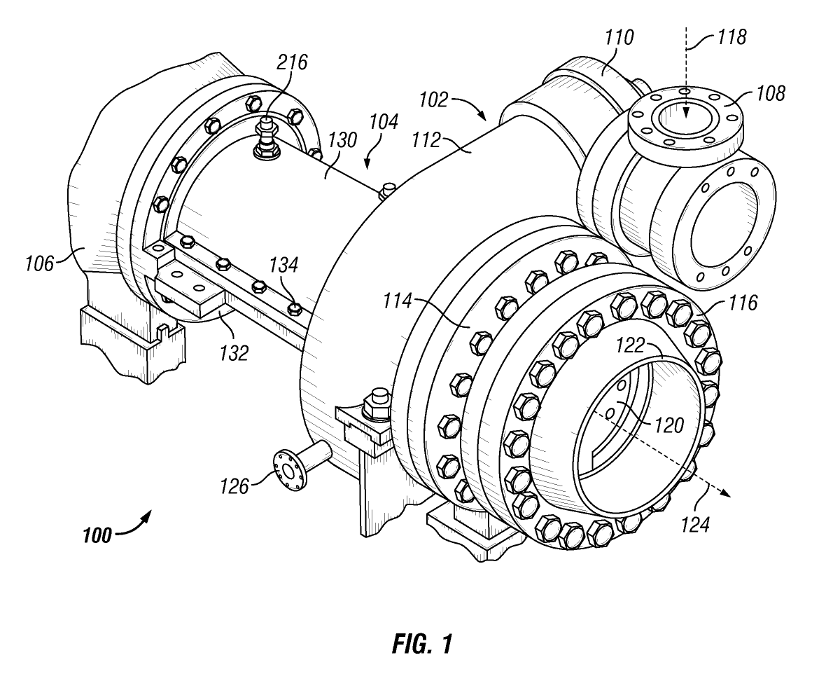

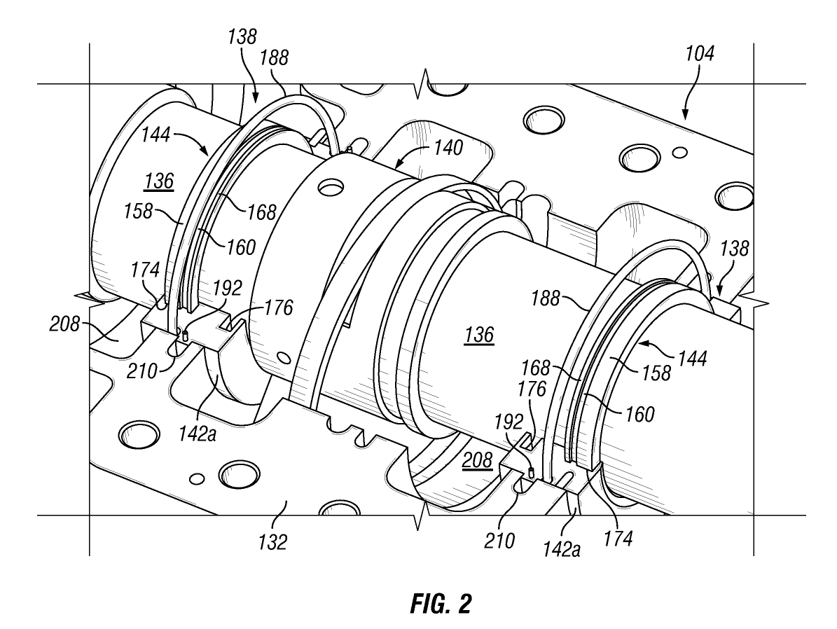

The disclosure generally relates to embodiments of a seal assembly 138 as shown in FIGS. 2-5B, and as disclosed herein, that may be used to seal a bearing housing of a turbine, such as a steam turbine. More particularly, one or more of the embodiments disclosed herein may be used to seal a bearing housing of a single-stage steam turbine. Before turning to the detailed description of the aspects of the seal assembly 138, however, an exemplary turbine will be described so that the unique aspects of the seal assembly 138 will be more readily appreciated. FIG. 1 illustrates an exemplary turbine 100 into which embodiments of the seal assembly 138 disclosed herein may be installed and used. In particular, illustrated is an overhung steam turbine. Nevertheless it will be appreciated by those skilled in the art that the various embodiments of the seal assembly 138 as disclosed herein may be equally applied to other types and designs of turbines. For example, turbines having a shaft supported on each end by bearings may likewise employ at least one embodiment of the seal assembly 138, without departing from the scope of the disclosure.

The turbine 100 generally includes a turbine housing 102, a bearing housing 104, and a transmission housing 106. The turbine housing 102 includes a steam inlet 108 generally connected to a source of pressurized steam (not shown), a governor valve housing 110, an annular steam chest 112, a rotor housing 114, and an exhaust outlet housing 116. In operation, the pressurized steam enters the inlet 108 in the direction indicated by arrow 118, passes through a governor valve (not shown) arranged within the governor valve housing 110, and into the annular steam chest 112. From the annular steam chest 112, the pressurized steam passes through the rotor housing 114 and exhaust steam exits through a diffuser 120 defined by the exhaust outlet housing 116 and an exhaust port 122 in the general direction indicated by arrow 124.

Housing drains and gland exhaust ports 126 may also be provided flanking the annular steam chest 112 on at least one side. The transmission housing 106 may house or otherwise enclose a suitable reduction gear and other load bearing elements adapted for power generation and conversion.

In at least one embodiment, the bearing housing 104 includes a horizontally-split housing formed of a first housing section 130 and a second housing section 132. The first and second housing sections 130, 132 may be coupled together along their respective flanged, contiguous sides by bolts 134 or similar mechanical attachment devices. Although the bearing housing 104 as shown is formed from two housing sections, the bearing housing 104 may be formed from a plurality of housing sections, including three or more housing sections.

Referring now to FIG. 2, with continued reference to FIG. 1, the second housing section 132 of the bearing housing 104 is illustrated with the first housing section 130 removed such that a rotary shaft 136 is shown extending through the bearing housing 104 and through a plurality of exemplary seal assemblies 138 associated with the bearing housing 104, as will be described in more detail below. Although not shown, the rotary shaft 136 may ultimately extend into the transmission housing 106. The rotary shaft 136 may be part of a rotor assembly (not shown) arranged within the turbine housing 102 adjacent the annular steam chest 112. The rotor assembly may include a plurality of rotor vanes or buckets (not shown) axially-spaced from each other within the rotor housing 114. The plurality of rotor vanes or buckets may be configured to rotate past annular ports (not shown) defined within stators coupled to or otherwise formed within the annular steam chest 112. In operation, the pressurized steam courses through the annular steam chest 112, passing through the annular ports and rotor vanes, and drives the rotor vanes creating rotational movement. The resultant exhaust passes through the diffuser 120 and exits out of the turbine 100 via the exhaust port 122.

As shown in FIG. 2, a bearing assembly 140 may be arranged within the bearing housing 104 to provide support for the rotary shaft 136 as it rotates. In at least one embodiment, the bearing assembly 140 may include an oil film journal bearing, but in other embodiments, the bearing assembly 140 may include any other suitable type of bearing. Additionally, in other embodiments, the bearing housing 104 may include a plurality of bearing assemblies 140 including, but not limited to, one or more thrust bearing assemblies (not shown) arranged within the bearing housing 104 and configured to assist in minimizing axial movement of the rotary shaft 136.

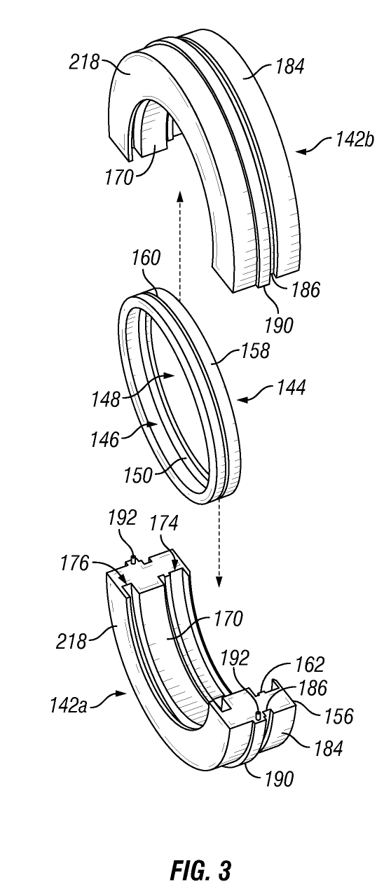

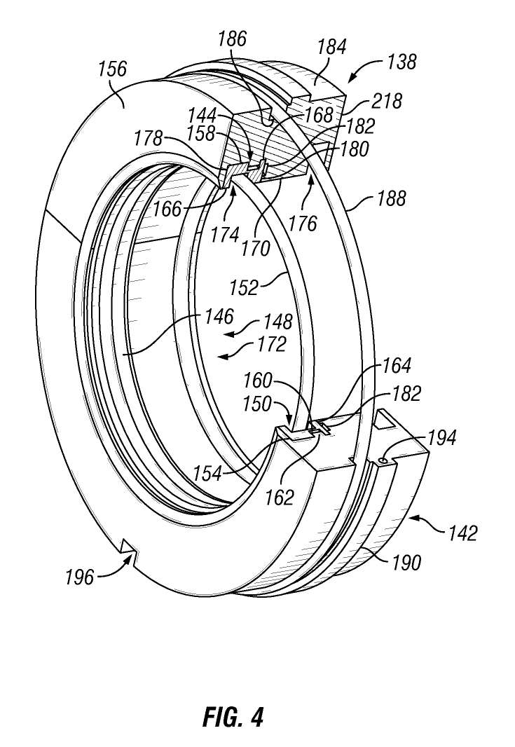

Referring now to FIGS. 3 and 4, with continued reference to FIG. 2, the seal assembly 138 may be configured to be disposed in the bearing housing 104 and to reduce or substantially prevent the encroachment of contaminants, such as moisture or other impurities, into the bearing housing 104, as contaminants, such as, for example, particulates including sand, may adversely affect the bearing assembly 140 and/or the lubricating oil used to lubricate the bearing assembly 140. In the embodiment illustrated in FIG. 2, the bearing housing 104 is configured to utilize a pair of the seal assemblies 138 arranged on each side of the bearing assembly 140; however, the number and location of the seal assemblies 138 employed may vary, depending at least in part on the bearing housing 104 provided for the particular turbine configuration.

The seal assembly 138 may include a stator seal member 142 and a rotor seal member 144 configured to be disposed within a portion of the stator seal member 142, as assembled and in operation. The rotor seal member 144 may form an annular ring having a unitary construction, or in other embodiments, a segmented construction. Accordingly, the rotor seal member 144 may be formed from a single or unitary piece or portion, or the rotor seal member 144 may be formed from multiple (e.g., two or more) segments, pieces, or portions of material. For example, in one embodiment, the rotor seal member 144 may be formed from two semi-annular rings, thereby forming a segmented annular ring upon assembly. As shown in the embodiments of FIGS. 2-5B, the rotor seal member 144 may be formed from a single piece. The rotor seal member 144 may be formed from polytetrafluoroethylene (PTFE) or PTFE alloy; however, the rotor seal member may be formed from any suitable material known in the art without departing from the scope of this disclosure.

The rotor seal member 144 may include an inner annular surface 146 defining a borehole 148 therethrough that is sized and configured to receive a portion of the rotary shaft 136. Accordingly, the diameter of the borehole 148 of the rotor seal member 144 may be dependent at least in part on the diameter of the rotary shaft 136. Generally, the rotor seal member 144 may be sized and configured to be disposed about and mounted to the rotary shaft 136 in a sealing relationship therewith. As shown in FIGS. 3-5B, the inner annular surface 146 of the rotor seal member 144 may form an inner annular groove 150 configured to receive and seat an O-ring 152 therein to further provide a sealing engagement between the rotor seal member 144 and the rotary shaft 136 when mounted thereto. The inner annular groove 150 may be formed adjacent a first axial end face 154 of the rotor seal member 144, and accordingly, may be adjacent a first axial end face 156 of the stator seal member 142 during operation.

The O-ring 152 may form an annular ring having a unitary construction, or in other embodiments, a segmented construction. Accordingly, the O-ring 152 may be formed from a single or unitary segment, piece, or portion or the O-ring 152 may be formed from multiple (e.g., two or more) segments, pieces, or portions of material. For example, in at least one embodiment, the O-ring 152 may be formed from two semi-annular rings, thereby forming a segmented annular ring upon assembly. In the embodiments illustrated in FIGS. 3-5B, the O-ring may be formed from a unitary piece. The O-ring 152 may be formed from any suitable elastomeric material known in the art.

The rotor seal member 144 may further include an outer annular surface 158 radially opposing the inner annular surface 146 and forming an outer annular groove 160. The outer annular groove 160 may be configured to receive a radial projection 162 of the stator seal member 142, which will be discussed in more detail below. The outer annular groove 160 may be formed adjacent a second axial end face 164 of the rotor seal member 144 axially opposing the first axial end face 154 of the rotor seal member 144. Each of the first and second axial end faces 154, 164 of the rotor seal member 144 may include a respective annular flange, illustrated as a first annular flange 166 and a second annular flange 168.

The stator seal member 142 may form an annular ring having a segmented construction, or in other embodiments, a unitary construction. Accordingly, the stator seal member 142 may be formed from multiple (e.g., two or more) segments, pieces, or portions of material. For example, the stator seal member 142 may be formed from two semi-annular rings, shown in the embodiment of FIGS. 2-5B as a first stator seal segment 142a and a second stator seal segment 142b forming a segmented annular ring upon assembly. The stator seal member 142 may be formed from polytetrafluoroethylene (PTFE) or PTFE alloy; however, the stator seal member 142 may be formed from any suitable material known in the art without departing from the scope of this disclosure.

The stator seal member 142 (and the stator seal segments 142a, 142b thereof) may include an inner annular surface 170 defining a borehole 172 therethrough that is sized and configured to receive a portion of the rotary shaft 136. Accordingly, the diameter of the borehole 172 of the stator seal member 142 may be based on the diameter of the rotary shaft 136. Generally, the diameter of the borehole 148 of the rotor seal member 144 and the diameter of the borehole 172 of the stator seal member 142 may be substantially similar, and in at least one embodiment, may be equal. As shown in FIGS. 3-5A, the inner annular surface 170 of the stator seal member 142 may further form a plurality of inner annular grooves 174, 176, illustrated as a first inner annular groove 174 and a second inner annular groove 176. In at least one embodiment, the first inner annular groove 174 may be configured to receive the rotor seal member 144 therein, and the second inner annular groove 176 may be configured to receive and provide a pathway for lubricant, e.g., oil, to flow therethrough.

The first inner annular groove 174 may include the radial projection 162, disclosed above, extending from the inner annular surface 170 and configured to be disposed within the outer annular groove 160 of the rotor seal member 144 when the rotor seal member 144 is disposed within the first inner annular groove 174. In at least one embodiment, the radial projection 162 is configured to align the rotor seal member 144 with the stator seal member 142 to reduce axial movement between the rotor seal member 144 and the stator seal member 142. The first inner annular groove 174 may further be defined by opposing axial sidewalls 178, 180, illustrated most clearly in FIG. 4 as a first axial sidewall 178 and a second axial sidewall 180. In an exemplary embodiment, the second axial sidewall 180 may further define an annular recess 182 adjacent the second annular flange 168 of the rotor seal member 144. The annular recess 182 may be configured to allow lubricant to flow therethrough to reduce friction between the rotor seal member 144 and the stator seal member 142.

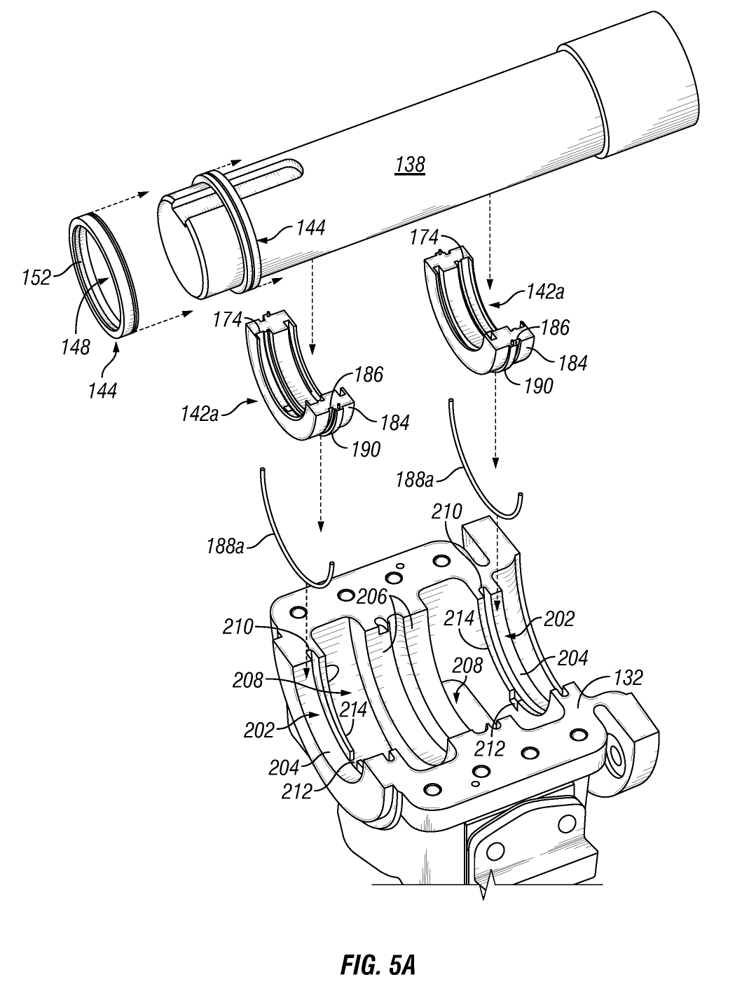

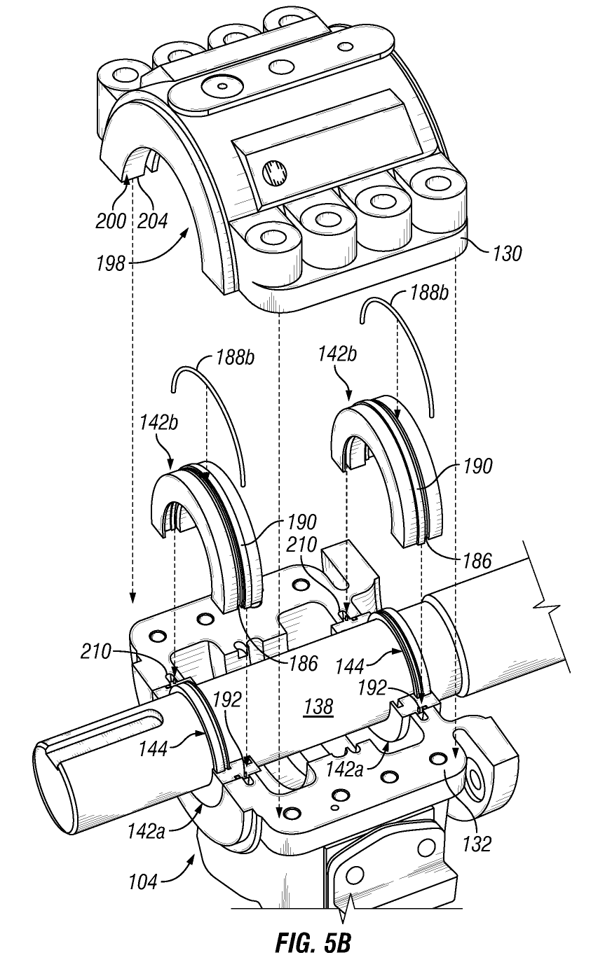

The stator seal member 142 (and the stator seal segments 142a, 142b thereof) may further include an outer annular surface 184 radially opposing the inner annular surface 170 and forming an outer annular groove 186. The outer annular groove 186 may be configured to receive and seat an O-ring 188 therein to further provide a sealing engagement between the stator seal member 142 and the bearing housing 104. In an exemplary embodiment, the O-ring 188 may form an annular ring having a segmented construction. Accordingly, the O-ring 188 may be formed from multiple (e.g., two or more) segments, pieces, or portions of material. For example, as shown in FIGS. 5A and 5B, the O-ring 188 may be formed from two semi-annular rings, illustrated as a first O-ring segment 188a and a second O-ring segment 188b and forming a segmented annular ring upon assembly. The O-ring 188 may be formed from any suitable elastomeric material known in the art.

The outer annular groove 160 may be formed adjacent a radial projection 190 extending radially from the outer annular surface 184. The radial projection 190 may include one or more alignment members 192, illustrated as alignment pins in FIG. 3, extending from respective end portions of at least one of the stator seal segments 142a, 142b of the stator seal member 142. The radial projection 190 may further define respective openings 194 (one shown in FIG. 4) in the end portions of the corresponding stator seal segments 142a, 142b of the stator seal member, such that the openings 194 are arranged to align with and receive the respective alignment members 192, thereby mating the stator seal segments 142a, 142b of the stator seal member 142 with one another during assembly.

The outer annular surface 184 and the first axial end face 156 of the stator seal member 142 may further define an exit port 196 configured to remove condensate and other impurities from the bearing housing 104. The exit port 196 may be in fluid communication with the inner annular groove 174 via a pathway (not shown) formed in the stator seal member 142 and configured to allow for the removal of condensate and other impurities from the inner annular groove 174 to and through the exit port 196 to a location external to the bearing housing 104.

Turning now to an exemplary method of assembly of the seal assembly 138 within the bearing housing 104, FIGS. 5A and 5B illustrate exploded views of the bearing housing 104 and a pair of the seal assemblies 138, according to one or more embodiments. For simplicity, the bearing assembly of the bearing housing 104 is omitted from FIGS. 5A and 5B; however, one of ordinary skill in the art will appreciate that a bearing assembly similar to the bearing assembly 140 illustrated in FIG. 2 may be included and utilized therein. The bearing housing 104 may include an inner annular surface defining a borehole 198 configured to receive at least the rotary shaft 136, the seal assemblies 138, and the bearing assembly. As illustrated, the bearing housing 104 may be split in half to include the first housing section 130 and the second housing section 132 in order to facilitate installation and maintenance of the seal assemblies 138 and bearing assembly 140. Accordingly, the inner annular surface may be formed from a semi annular inner surface 200 of the first housing section 130 and a semi annular inner surface 202 of the second housing section 132.

As the seal assemblies 138 in FIGS. 5A and 5B are identical and oriented to mirror one another, for the sake of brevity, the exemplary method of assembly shown in FIGS. 5A and 5B will only be described in reference to a single seal assembly 138; however, those of ordinary skill in the art will appreciate the applicability of the disclosure to the other seal assembly shown. The semi annular inner surface 202 of the second housing section 132 defining the borehole 198 may be segmented to include one or more seal assembly portions 204 (two are shown in FIG. 5A) and one or more bearing assembly portions 206 (one is shown in FIG. 5A). Disposed therebetween may be a sump 208 configured to collect lubricant, and in addition, condensates and other impurities in the bearing housing 104. The seal assembly portion 204 may define a bearing housing groove 210 in fluid communication with the sump 208 via a drainage opening 212 defined in a sidewall 214 common to the bearing housing groove 210 and the sump 208.

The semi annular O-ring segment 188a of the O-ring 188 may be disposed on the seal assembly portion 204 adjacent the bearing housing groove 210 and the first stator seal segment 142a may be disposed on the seal assembly portion 204 and the semi annular O-ring segment 188a, such that the semi annular O-ring segment 188a is seated within the outer annular groove 186 may be configured to provide a sealing engagement between the stator seal member 142 and the bearing housing 104. Further, the first stator seal segment 142a may be disposed on the seal assembly portion 204 such that the radial projection 190 extending radially from the outer annular surface 184 is seated within the bearing housing groove 210. The radial projection 190 may be configured and seated within the bearing housing groove 210 such that axial movement of the first stator seal segment 142a may be prevented, thereby allowing for proper alignment with the rotor seal member 144.

The O-ring 152 may be seated within the inner annular groove 150 formed in the inner annular surface 146 of the rotor seal member 144. The rotor seal member 144 may be press fit or otherwise mounted on the rotary shaft 136 at a location on the rotary shaft 136 corresponding to the disposition of the rotary shaft 136 in relation to the stator seal member 142 in the bearing housing 104. As mounted on and disposed about the rotary shaft 136, the rotor seal member 144 may provide a sealing engagement between the rotor seal member 144 and the rotary shaft 136. Upon mounting the rotor seal member 142 on the rotary shaft 136, the rotary shaft 136 may be disposed in the bearing housing 104, such that the rotor seal member 144 is arranged within the inner annular groove 174 of the stator seal member 142.

Accordingly, the second stator seal segment 142b may be aligned with the first stator seal segment 142a via the alignment members 192 and corresponding openings 194, such that the first and second stator seal segments 14a, 142b are aligned and mated with one another about the rotor seal member 144. The corresponding semi annular O-ring segment 188b of the O-ring 188 may be seated within the outer annular groove 186 of the second stator seal segment 142b adjacent the radial projection 190 extending radially from the outer annular surface 184. The first housing section 130 of the bearing housing may be placed on top of the second stator seal segment 142b such that the semi annular O-ring segment 188b provides a sealing engagement between the stator seal member 142 and the bearing housing 104 and the radial projection 190 is seated within the bearing housing groove 210. The first housing section 130 and second housing section 132 of the bearing housing 104 may be secured to one another via mechanical fasteners, such as bolts 134 (see FIG. 1), inserted through respective openings in the flanges of the first housing section 130 and second housing section 132 of the bearing housing 104.

In exemplary operation of the seal assembly 138 in a turbomachine, such as a steam turbine of FIG. 1, with further reference to FIGS. 2-5B, lubricant (not shown) may be introduced to the bearing housing via inlet port 216. The O-ring 188 providing a sealing engagement between the stator seal member 142 and the bearing housing 104 prevents oil from escaping from the bearing housing 104 around the outside of the stator seal member 142, and the O-ring 152 providing a sealing engagement between the rotor seal member 144 and the rotary shaft 136 prevents contaminants and other impurities from traveling into the bearing housing 104 along the surface of the rotary shaft 136 Lubricant and contaminants may be dynamically prevented from traveling in a radial direction through the interface between the stator seal member 142 and the rotor seal member 144 as explained in more detail below.

Lubricant may travel outwardly along the rotary shaft 136 toward a second axial end face 218 of the stator seal member 142. During operation of the steam turbine, as the lubricant travels outwardly along the rotary shaft 136, the rotary shaft 136 is rotated, such that lubricant is thrown by centrifugal force into the second inner annular groove 176. The lubricant may drain by gravity into the drainage opening 212 and then into the sump 208, where the lubricant may be removed and recycled for lubrication of the bearing assembly 140. To this end, the stator seal member 142 and the rotary shaft 136 may be used in conjunction to dynamically prevent lubrication from exiting the bearing housing 104.

In operation, the geometry of the rotor seal member 144 may prevent contaminants from traveling toward the interior of the bearing housing 104 from the external environment and reaching the second axial end face 164 of the rotor seal member 144. To this end, the geometry of the outer annular surface 158 of rotor seal member 144 from the first axial end face 154 to the second axial end face 164 includes the outer annular groove 160. Contaminants traveling inwardly through the bearing housing 104 in the spacing between the rotor seal member 144 and the stator seal member 142 contact the surface of the outer annular groove 160. The rotation of the rotor seal member 144 causes the contaminants to be thrown by centrifugal force toward the stator seal member 142 where the contaminants are drained via gravity to and through the exit port 196 to a location external of the bearing housing 104.

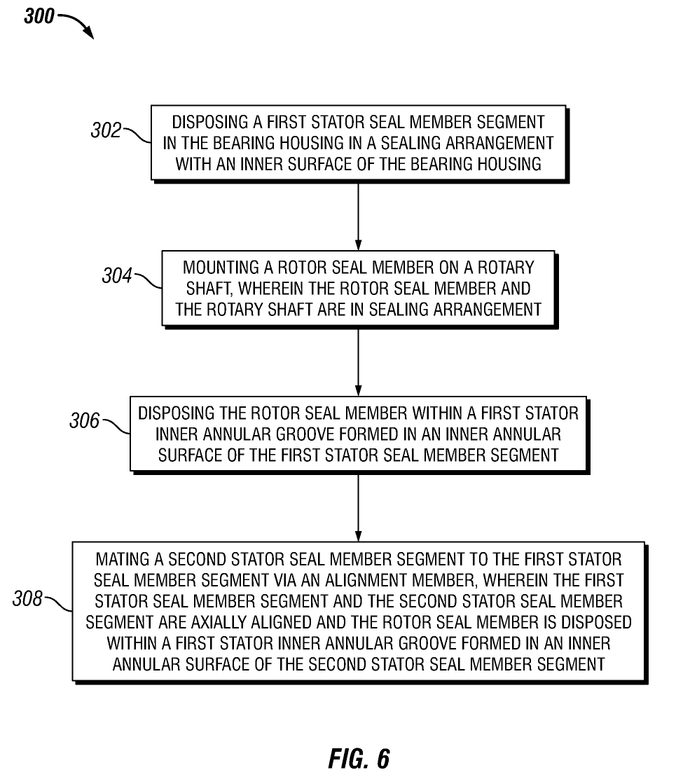

FIG. 6 illustrates a schematic flowchart of a method 300 for assembling a seal assembly for a turbomachine. The method 300 may include disposing a first stator seal member segment in the bearing housing in a sealing arrangement with an inner surface of the bearing housing, as at 302. The method 300 may also include mounting a rotor seal member on a rotary shaft, where the rotor seal member and the rotary shaft are in sealing engagement, as at 304. The disposition of the rotor seal member on the rotary shaft may correspond to the positioning of the rotary shaft in the bearing housing in relation to the first stator seal segment. The method 300 may further include disposing the rotor seal member within a first stator inner annular groove formed in an inner annular surface of the first stator seal member segment, as at 306. The method 300 may also include mating a second stator seal member segment to the first stator seal member segment via an alignment member, wherein the first stator seal member segment and the second stator seal member segment are axially aligned and the rotor seal member is disposed within a first stator inner annular groove formed in an inner annular surface of the second stator seal member segment, as at 308.

The foregoing has outlined features of several embodiments so that those skilled in the art may better understand the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions and alterations herein without departing from the spirit and scope of the present disclosure.

We claim:

1. A seal assembly for a bearing housing, comprising:
a rotor seal member defining a borehole configured for a rotary shaft to extend therethrough, the rotor seal member configured to be in sealing engagement with the rotary shaft; and
a stator seal member formed from a plurality of stator seal member segments and configured to be in sealing engagement with the bearing housing, the stator seal member comprising:
a first stator axial end face adjacent a first rotor axial end face;
a second stator axial end face axially opposite the first stator axial end face and configured to be disposed at or adjacent to an axial end of the bearing housing;
an annular stator outer surface configured to be disposed on an inner surface of the bearing housing in sealing engagement therewith; and
an annular stator inner surface radially opposing the annular stator outer surface and forming a first stator inner annular groove configured to receive the rotor seal member therein and form a sealing engagement therewith.

2. The seal assembly of claim 1, wherein the annular stator inner surface further forms a second stator inner annular groove adjacent the second stator axial end face and configured to direct lubricant to a sump formed in the bearing housing.

3. The seal assembly of claim 1, further comprising:
a stator inner radial projection extending radially inward from the first stator inner annular groove; and
an outer rotor annular surface of the rotor seal member forming an outer rotor surface annular groove configured to receive the stator inner radial projection therein.

4. The seal assembly of claim 1, further comprising a first O-ring configured to be disposed within a rotor inner annular groove formed in an annular inner surface of the rotor seal member, thereby forming a sealing engagement with the rotary shaft.

5. The seal assembly of claim 4, wherein the rotor seal member and the first O-ring are each a unitary piece.

6. The seal assembly of claim 5, further comprising a second O-ring configured to be disposed within a stator annular groove formed in the annular stator outer surface of the stator seal member, thereby forming a sealing engagement with the bearing housing.

7. The seal assembly of claim 6, wherein the second O-ring is formed from a plurality of O-ring segments.

8. The seal assembly of claim 1, wherein the stator seal member is formed from a first stator seal member segment and a second stator seal member segment, wherein:
the first stator seal member segment comprises a segment end portion and an alignment member extending from the segment end portion, and
the second stator seal member segment defines a segment opening configured to receive the alignment member therein and arranged such that the first stator seal member segment and the second stator seal member segment are axially aligned after the alignment member is disposed within the segment opening.

9. The seal assembly of claim 1, wherein a stator outer radial projection extends radially outward from the annular stator outer surface, the stator outer radial projection configured to be received in and seated in a bearing housing inner annular groove formed in the inner surface of the bearing housing, such that axial movement of the stator seal member in relation to the bearing housing is prevented after the stator outer radial projection is seated in the bearing housing inner annular groove.

10. The seal assembly of claim 1, wherein the first stator inner annular groove is further defined by a first axial sidewall and a second axial sidewall, wherein the second axial sidewall forms an annular recess configured to allow lubricant to flow therethrough and to maintain a spacing between the rotor seal member and the stator seal member.

11. The seal assembly of claim 1, wherein the stator seal member further defines an exit port in the annular stator outer surface, the exit port in communication with the first stator inner annular groove, such that any contaminants in the bearing housing are directed to the exit port via gravity from the first stator inner annular groove.

12. A seal assembly for a bearing housing of a turbomachine, comprising:
an annular rotor seal member defining a borehole configured to receive a rotary shaft of the turbomachine;
a first stator seal member segment comprising an alignment member; and
a second stator seal member segment defining an opening configured to receive and seat the alignment member, wherein the first stator seal member segment and the second stator seal member segment are axially aligned and form an annular stator seal member with the alignment member seated within the opening, the annular stator seal member comprising an annular stator seal member outer surface and an annular stator seal member inner surface disposed radially inward from the annular stator seal member outer surface, the annular stator seal member forming:
a first stator inner surface annular groove disposed adjacent an axial end face of the annular stator seal member and configured to receive the annular rotor seal member therein and to form a sealing engagement therewith;
a second stator inner surface annular groove configured to direct lubricant to a sump formed in the bearing housing, the second stator inner surface annular groove disposed adjacent an opposing axial end face of the axial end face of the annular stator seal member;
a stator outer surface annular groove; and
a stator annular projection extending radially outward from the annular stator seal member outer surface and disposed adjacent the stator outer surface annular groove, the stator annular projection configured to be received in an inner surface groove of the bearing housing, such that axial movement of the annular stator seal member in relation to the bearing housing is prevented.

13. The seal assembly of claim 12, further comprising a first O-ring configured to be disposed within a rotor inner surface annular groove formed in an annular inner surface of the rotor seal member, thereby forming a sealing engagement with the rotary shaft.

14. The seal assembly of claim 13, wherein the rotor seal member and the first O-ring are each a unitary piece.

15. The seal assembly of claim 13, further comprising a second O-ring formed from a plurality of second O-ring segments and configured to be disposed within the stator outer surface annular groove formed in the annular stator seal member outer surface, thereby forming a sealing engagement with the bearing housing.

16. The seal assembly of claim 12, further comprising:
a stator inner surface projection extending radially inward from the first stator inner surface annular groove; and
an outer annular surface of the rotor seal member forming a rotor outer surface annular groove configured to receive the stator inner surface projection therein.

17. A method for assembling a seal assembly in a bearing housing, comprising:
disposing a first stator seal member segment in the bearing housing in a sealing arrangement with an inner surface of the bearing housing;
mounting a rotor seal member on a rotary shaft, wherein the rotor seal member and the rotary shaft are in sealing engagement;
disposing the rotor seal member within a first stator inner annular groove formed in an inner annular surface of the first stator seal member segment; and
mating a second stator seal member segment to the first stator seal member segment via an alignment member, wherein the first stator seal member segment and the second stator seal member segment are axially aligned and the rotor seal member is disposed within a first stator inner annular groove formed in an inner annular surface of the second stator seal member segment.

18. The method of claim 17, further comprising:
seating a first stator O-ring segment in a stator outer annular groove formed in an annular stator outer surface of the first stator seal member segment, thereby creating the sealing engagement between the bearing housing and the first stator seal member segment;
seating a second stator O-ring segment in a stator outer annular groove formed in an annular stator outer surface of the second stator seal member segment, thereby creating the sealing engagement between the bearing housing and the second stator seal member segment; and
seating a rotor O-ring in a rotor inner annular groove formed in an annular rotor inner surface of the rotor seal member, thereby creating the sealing engagement between the rotor seal member and the rotary shaft.

19. The method of claim 17, further comprising seating a stator outer radial projection extending radially outward from the each of the first stator seal member segment and the second stator seal member segment in a bearing housing groove defined in the inner surface of the bearing housing, such that axial movement of the first stator seal member segment and the second stator seal member segment in relation to the bearing housing is prevented.

20. The method of claim 17, further comprising heating the rotor seal member prior to mounting the rotor seal member on the rotary shaft.
